(19) United States
(12) Patent Application Publication
(10) Pub. No.: US 2026/0196148 A1
(43) Pub. Date: Jul. 9, 2026

(54) TRADE JACKET FOR DISPLAYING INFORMATION ABOUT A TRADE ITEMS HELD WITHIN A TRADE HOLDER

(71) Applicant: MARK WESLEY DORAN, AUSTIN, TX (US)

(72) Inventor: MARK WESLEY DORAN, AUSTIN, TX (US)

(21) Appl. No.: 19/442,179

(22) Filed: Jan. 7, 2026

Related U.S. Application Data
(60) Provisional application No. 63/742,577, filed on Jan. 7, 2025.

(51) Int. Cl. G09F 5/02

(52) U.S. Cl. CPC G09F 5/02

(57) ABSTRACT

The trade jacket is a printable or hand-writable piece of paper or similar material of varying types that can be attached to a paper, cardboard, plastic, wood, or metal trade holder that allows recording of information about the item contained within the trade holder. A trade holder is a device similar to a folder having two sides that fold or are pre-folded together, and a window of varying sizes including the entirety of the holder, typically made of Mylar or similar materials but generally of a non-PVC polypropylene type material archival in nature, and can be side, bottom, top, or openly loaded with a trade item. FIG. 1 represents an example of a trade holder that is a cardboard coin holder.

This application claims the benefit of U.S. Provisional Patent Appl. Ser. No. 63/742,577, filed on Jan. 7, 2025.

### BACKGROUND OF THE INVENTION

### Field of the Invention

This invention pertains to trade holders, including for example coin jackets in the area of numismatics, the hobby of collecting coins, or like articles such as tokens, medals, and challenger coins, bank notes, ticket stubs, trading cards, comic book, stamps, baseball cards, or any combination thereof, or any other commonly traded items held within a trade holder. These articles may be of varying compositions.

### Description of the Related Art

Currently, the fields of tradable objects and its affiliated fields do not have a trade jacket like device.

To continue with the numismatic example, the industry produces coin holders with pre-printed dates and variants. These are typically within a book that allows the user to insert the specific coin in a slot when the coin is obtained. Space for writing within these books is severely limited.

It is not uncommon to find notes on the outside of a coin holder. However, the space allotment is very limited. A typically coin holder is 2″×2″, made of archival grade material, and has a clear window of varying sizes in the middle that allows a person to see the coin without holding or removing it from the protective holder. The larger the coin, the bigger the window, and the less space for putting information on the coin holder about the coin or its provenance.

Collectors may use index cards to write notes and place them on or with the coin or separately in another location for reference purposes. Spreadsheets are another common manner to keep notes about a collection. The coin jacket of the current invention has several advantages over the prior art, including for example the ability to be attached to the relevant coin.

If the coin holder is plastic, typically, the only way to write information about the coin is by using a label and applying it with an adhesive, either self-adhering or otherwise. This does not allow the user any more space than the cardboard coin holder itself, as the window to view the coin must still be viewable and should not be obstructed. This principle applies broadly across trade holders, as the object of said trade holders is to protect the item while maximizing the viewable area.

All prior art methods allow very little space for writing about the trade item or its provenance. While the trade jacket of the current invention can cover the entire front or reverse, the trade jacket easily flips out of the way, thus allowing the user to quickly view the entirety of the tradable item.

The trade jacket can come in a single form or on a premade sheet of paper for ease of printing. The paper can be any suitable material known in the art, such as for example, onion paper or heavy archival paper, or other non-paper alternatives. This range of paper can vary in size from 0.0012-0.012. For printers, the trade jacket may have a micro-perforation along the outer edges, so the user can easily remove the coin jacket from the paper source. The teeth per inch (TPI) can vary, for example, from 5 TPI to 72 TPI or even by laser cut.

### SUMMARY OF THE INVENTION

The trade jacket assists when attempting to write or print information about a tradable item on the outside of, for example, a 2″×2″ cardboard coin holder. The space for writing is very limited, and the trade jacket allows one to highlight the meaning and stories behind, in this example, the coin or object. Without the trade jacket of the present invention, there may be insufficient room for this information within the current construct of trade holders.

Additionally, handwriting may not be very clear. Using a label maker is impractical as it is too big in many cases. The trade jacket of the present invention allows one to hand write or print on it. A person of skill in the art will appreciate the flexibility enabled by this invention.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a prior art example of a cardboard coin holder.

FIG. 2 illustrates the front side view of a flat coin jacket.

FIG. 3 illustrates the back side view of a flat coin jacket.

FIG. 4 illustrates the side view of a flat coin jacket.

FIG. 5 illustrates the side view of a folded coin jacket.

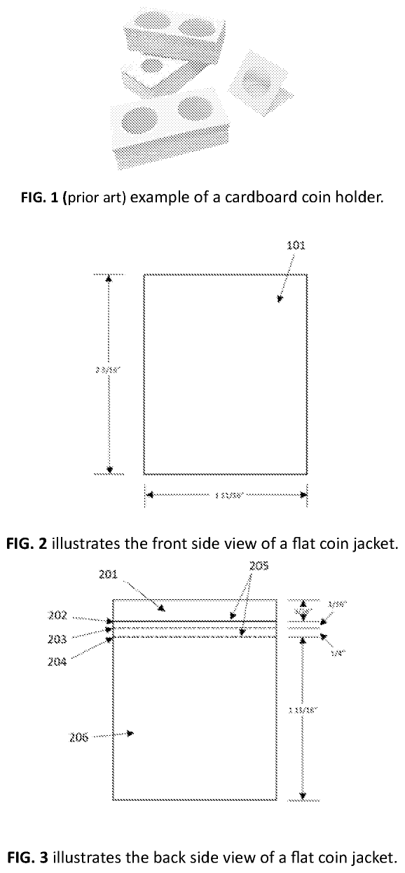

### DETAILED DESCRIPTION OF THE INVENTION

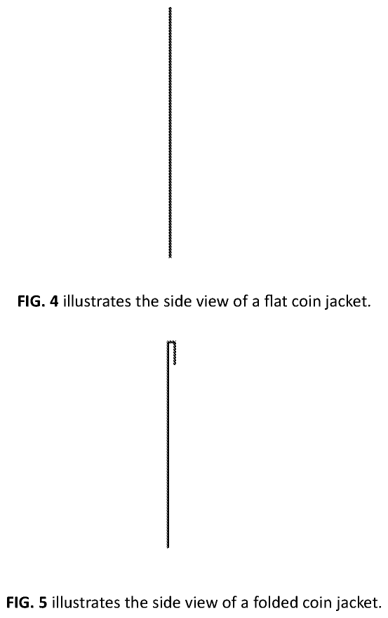

Exemplary embodiments and their advantages are best understood by reference to FIGS. 2-5, wherein like numbers are used to indicate like and corresponding parts unless expressly indicated otherwise.

In the following description, details are set forth by way of example to facilitate discussion of the disclosed subject matter. While the coin jacket is used for example purposes, it should be apparent to a person of ordinary skill in the field, however, that the disclosed embodiments are exemplary and not exhaustive of all possible embodiments of the trade jacket of the current invention.

Throughout this disclosure, a hyphenated form of a reference numeral refers to a specific instance of an element and the un-hyphenated form of the reference numeral refers to the element generically. Thus, for example, “device 2-1” refers to an instance of a device class, which may be referred to collectively as “devices 2” and any one of which may be referred to generically as “a device 2”.

FIG. 2 illustrates a perspective view of the front side of an exemplary coin jacket. The front side of the exemplary coin jacket provides approximately 2″×2″ of space for the user to put any information in area 101, including but not limited to origin of country, year minted, mint location, provenance, grade, denomination, any errors, series, variety, mintage size, coin value, purchase price, description, thickness, diameter, weight, edge type, composition, designer, Krause number, obverse or reverse design elements, translation, or other information such as a logo, image of the coin in mint condition or otherwise, and ownership. This same principle applies to FIG. 3, area 206.

Embodiments of the exemplary coin jacket shown in FIG. 2 may have pre-printed information, such as for example for a specific brand, logo, image, coin, a series, or otherwise. The overall dimensions may vary in both length and width. While the most common coin holders are 2″×2″, there other sizes are possible. For example, a 2.5″×2.5″ coin holder is designed for extra-large coins. In this case, the dimensions for the exemplary coin flap may be 2.5″×2.875″.

Additionally, areas 101 and 206 can be extended in length to flip over two or more times allowing for even more information to be presented on areas 101 and 206. In this instance, the two or more flips could be folded back under the initial cover of the first flip and could further be scored for easy bending. Each additional fold could increase the length of the jacket by two inches or more depending upon the size of the coin holder.

In another exemplary embodiment, a coin holder may be extra thick, or a coin may be encased in a coin slab with a certain thickness. This thickness may require the overall length of the coin jacket to be slightly increased. In such an exemplary embodiment, pre-marked fold lines 202, 203, and 204 may be used to create folds that allow the coin holder to wrap around the top, side, or bottom of said coin holders and still cover the entirety of the obverse or reverse of the coin holder.

FIG. 3 highlights certain aspects of an exemplary coin jacket. Attachment wing 201 affixes the coin jacket to the coin holder. The user may attach the coin jacket to a cardboard coin holder using a stapler (a common practice with cardboard coin holders) in between the two sides of the coin holder, and thus inside the holder or on either end of the coin holder on the outside. In case of a self-adhesive coin holder or a plastic type coin holder, the user can place the coin jacket between the two wings of the coin holder or on either end of the coin holder using an adhesive tape or glue.

Exemplary embodiments of the coin jacket may include a self-adhesive strip where the user can simply peel off a protective covering of the adhesive strip and affix it using the exposed adhesive. The shown 3/16 size of the appendage is the most common width between the top of the coin holder and the clear window that allows the coin to be seen and protected for a larger coin. Other sizes, either smaller or larger, are possible. Further exemplary embodiments may include an appendage with a precut hole that covers part or the entirety of a side of a coin holder, thus allowing the user to print more information or embellishments.

Pre-marked fold lines 202, 203, and 204 are guidelines for the user to properly align the coin jacket with the coin holder. Alternatively, these could be scored lines allowing for an easier and smoother bending of the coin jacket. Area 205 is a spine for printing or writing.

This disclosure encompasses all changes, substitutions, variations, alterations, and modifications to the example embodiments herein that a person having ordinary skill in the art may envision or comprehend. Similarly, where appropriate, the appended claims encompass all changes, substitutions, variations, alterations, and modifications to the example embodiments herein that a person having ordinary skill in the art may envision or comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended as pedagogical objects to aid the reader in understanding the disclosure and the concepts contributed by the inventor to furthering the art, and should be construed as being without limitation to such specifically recited examples and conditions. Although embodiments of the present disclosure have been described in detail, it should be understood that various changes, substitutions, and alterations could be made hereto without departing from the spirit and scope of the disclosure.

The trade jacket covers a realm of collecting which is currently not readily available to the collecting public.

I claim:

1. A trade jacket for displaying information about a trade item held by a separate trade holder, the trade jacket comprising:
an information panel comprising a writable or printable information area;
at least one pre-scored fold line configured to allow the information panel to flip relative to the trade holder;
a spine portion extending along an edge of the information panel;
an attachment wing extending from the information panel and configured to secure the trade jacket to the trade holder; and
wherein the attachment wing comprises at least one attachment feature configured to affix the trade jacket to the trade holder without substantially obstructing viewing of the trade item contained therein when open.

2. The trade jacket of claim 1, wherein the information panel comprises a plurality of writable or printable information areas positioned on opposing sides of the information panel.

3. The trade jacket of claim 1, comprising a plurality of pre-scored fold lines configured to permit multiple sequential flips of the information panel.

4. The trade jacket of claim 3, wherein each flip increases the available information area without permanently obscuring the trade holder.

5. The trade jacket of claim 1, wherein the attachment feature comprises a self-adhesive strip disposed on the attachment wing.

6. The trade jacket of claim 1, wherein the attachment wing is configured for attachment using one or more of a staple, adhesive tape, glue, or insertion between folded portions of the trade holder.

7. The trade jacket of claim 1, wherein the spine portion is configured to receive printed or handwritten information.

8. The trade jacket of claim 1, wherein the trade jacket is formed from paper, archival paper, onion paper, or a non-paper archival material.

9. The trade jacket of claim 8, wherein the material has a thickness in a range of approximately 0.0012 to 0.012 inches.

10. The trade jacket of claim 1, wherein the trade jacket is dimensioned to correspond to a 2 inch×2 inch trade holder.

11. The trade jacket of claim 1, wherein the trade jacket is dimensioned to correspond to a trade holder larger than 2 inch×2 inch.

12. The trade jacket of claim 1, wherein the trade jacket includes at least one pre-printed information selected from a logo, image, series designation, or branding.

13. The trade jacket of claim 1, wherein the trade jacket is provided on a sheet comprising a plurality of trade jackets.

14. The trade jacket of claim 13, wherein each trade jacket on the sheet is separable by a micro-perforation.

15. The trade jacket of claim 14, wherein the micro-perforation has a teeth-per-inch value in a range of approximately 5 to 72.

16. The trade jacket of claim 1, wherein the pre-scored fold line comprises a scored guideline to facilitate alignment of the trade jacket relative to the trade holder.

17. The trade jacket of claim 1, wherein the attachment wing is sized to fit within a gap between a viewing window of the trade holder and an outer edge of the trade holder.
